(19) United States
(12) Patent Application Publication
(10) Pub. No.: US 2025/0190899 A1
(43) Pub. Date: Jun. 12, 2025

(54) CALENDAR-BASED RESOURCE AND BILLING MANAGEMENT SOLUTION

(71) Applicant: Yang Yang, Burke, VA (US)

(72) Inventor: Yang Yang, Burke, VA (US)

(21) Appl. No.: 18/123,982

(22) Filed: Mar. 21, 2023

(51) Int. Cl. G06Q 10/0631; G06Q 30/04; G06Q 40/08; G06Q 40/12

(52) U.S. Cl. CPC G06Q 10/06314; G06Q 10/06313; G06Q 30/04; G06Q 40/08; G06Q 40/125

(57) ABSTRACT

The present invention comprises a software functionality that expands existing computer and web-based scheduling programs (e.g., calendar) in personal information management systems (e.g., Microsoft Outlook) to include customizable resource accounting categories (e.g., charge/cost codes). When used with time tracking and/or billing applications (e.g., Workday effort tracking system, ADP electronic timecards), it can transfer event details with time utilization and cost code information to timecards, while it can pull cost code information from time tracking applications to calendars. When used with computer monitoring/communication systems (e.g., audio/video conferencing tools), the invention integrates these systems with scheduling programs and/or time tracking and billing applications to automatically generate/update events on calendars with elapsed event details. The aggregate information inclusive of the user's entries is used for timekeeping/tracking and to determine resource utilization and resource and budget planning through reporting capabilities across multiple dimensions (e.g., users, projects, departments) over adjustable time periods (e.g., seconds, minutes, hours, days, weeks, months, years).

### TECHNICAL FIELD

The present invention comprises a software functionality that expands existing computer and web-based scheduling programs (e.g., calendar) in personal information management systems (e.g., Microsoft Outlook) to include customizable resource accounting categories (e.g., charge/cost codes). When used with time tracking and/or billing applications (e.g., Workday effort tracking system, ADP electronic timecards), it can transfer event details with time utilization and cost code information to timecards, while it can pull cost code information from time tracking applications to calendars. When used with computer monitoring/communication systems (e.g., audio/video conferencing tools), the invention integrates these systems with scheduling programs and/or time tracking and billing applications to automatically generate/update events on calendars with elapsed event details. The aggregate information inclusive of the user's entries is used for timekeeping/tracking and to determine resource utilization and resource and budget planning through reporting capabilities across multiple dimensions (e.g., users, projects, departments) over adjustable time periods (e.g., seconds, minutes, hours, days, weeks, months, years).

### BACKGROUND OF THE INVENTION

Managing resource allocation for activities and time utilization is a problem faced by millions of people, especially for those that use electronic time tracking and billing applications. Solutions for reporting time spent on a job are often retrospective, tedious, and error prone as employees are expected to allocate their time on applications that are not directly synchronized with their everyday scheduling programs for events/activities/tasks management (e.g., Google calendar, Apple calendar, Outlook calendar). Current time tracking applications are wholly reliant on employee self-reporting, which makes it susceptible to various forms of inaccuracies and extremely difficult to audit.

For conferencing, millions of people use computer and web-based scheduling programs to invite each other to meetings or to use them to time block for events/activities/tasks. However, these programs lack integration with resource accounting information (e.g., cost code database) that typically exist in time tracking and billing applications. Thus, to derive resourcing and budget insights, people have to use separate time tracking applications.

Another problem that exists in current computer and web-based scheduling programs is deviations from scheduled events/activities/tasks (e.g., shorter or long meetings) are not automatically updated to reflect time actually elapsed/spent. For example, an event scheduled for 60 minutes actually went over by 10 minutes; or conversely, an event scheduled for 60 minutes actually went under by 10 minutes. Lack of automatic adjustments in current scheduling programs contribute to inaccurate timekeeping.

For events that are not scheduled/blocked on calendars, people do not necessarily record them to reflect actual elapsed events. Especially for events that take place over computer monitoring/communication systems, they are not automatically added to scheduling programs as events that actually took place, which make tracking of efforts really difficult to enable resource planning.

Due to the existing practice of time reporting, insight on resource utilization is not necessarily available immediately to enable proactive resource and budget allocation and planning. Delayed reporting in existing solutions (e.g., timecards that are submitted monthly) results in lagging information critical to decision makers. Timely information can facilitate proactive management practices to address problems as they arise (e.g., accelerated recruitment efforts, resource redirection, more precise budgeting).

### SUMMARY OF INVENTION

The purpose of the invention is to manage time, resources and billing for individuals or organizations by integrating digital scheduling programs (e.g., calendar applications in Google, Apple, Outlook, Yahoo) with customizable resource accounting categories (e.g., charge codes, cost centers) that reside in time tracking and billing applications or in separate databases to enable resource planning and budgeting (e.g., headcount and money allocation, prioritization) through various levels of reporting (e.g., enterprise level, department level, group level).

It is another objective of this invention to integrate with electronic monitoring/communication systems (e.g., communication tools, phone, audio/video conferencing systems) to enable synchronization/auto-population of events/activities/tasks on scheduling systems to reduce manual entries and increase accuracy of time keeping.

Another objective of the invention is to integrate with electronic monitoring and communication systems (e.g., communication and conferencing tools, user log-on and inactivity monitors, printer monitoring, physical location tracking systems) to enable recognition of deviations in existing event details by updating scheduled events to reflect actual details (e.g., actual duration of a meeting) and adjusting start time of the successor event.

Another objective of the invention is to learn/adapt to user inputs and corrections to train/refine an algorithm that automatically matches charge codes from the database to scheduled activities, prioritizes frequently used codes, and recommends new charge codes/sub-level charge codes as appropriate to track sub-level event/activity/task that may be useful to record separately or together with the main event/activity/task.

Another objective of the invention is to provide customizable and aggregate reporting (e.g., summaries, trends) across multiple dimensions (e.g., users, departments, projects, costs) over variable timeframe (e.g., seconds, minutes, hours, days, weeks, months, years) to generate resource insights, payroll/billing information and audit trail for compliance purposes.

Another objective of the invention is to enable optional depersonalization, redaction, or anonymization of sensitive information for selected events to protect personally identifiable, confidential, or sensitive information to enable compliance with privacy, regulatory, and confidentiality policies and/or requirements (e.g., Health Insurance Portability and Accountability Act).

Another objective of the invention is to provide traceability and/or delegation of event entry and modifications (e.g., who and when changes are made, designating a delegate to modify certain events).

### DETAILED DESCRIPTION OF THE INVENTION

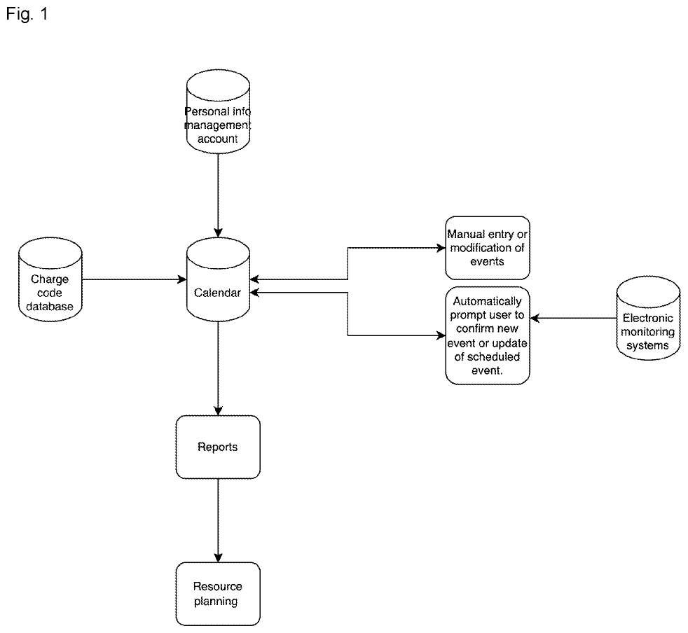

FIG. 1 illustrates the overall setup of the invention

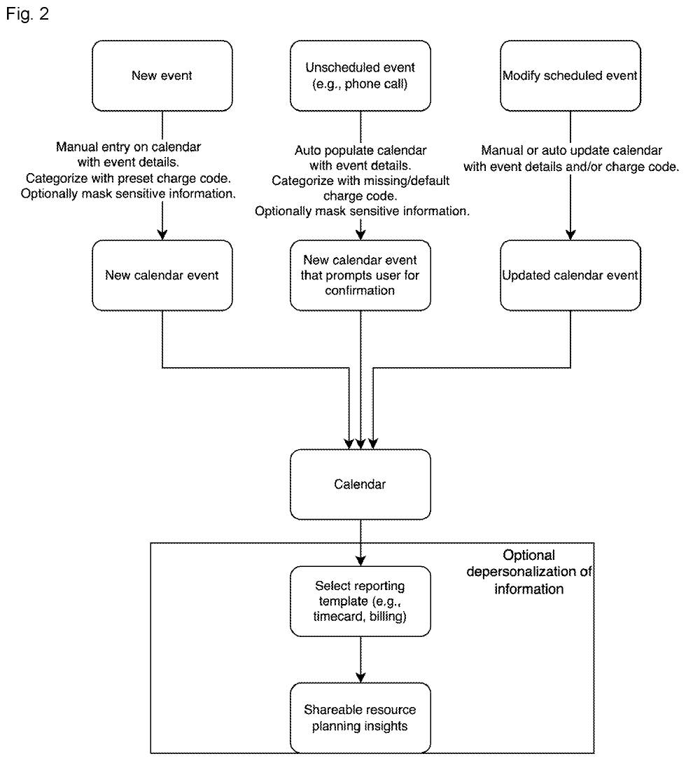

FIG. 2 illustrates user operations when utilizing the invention

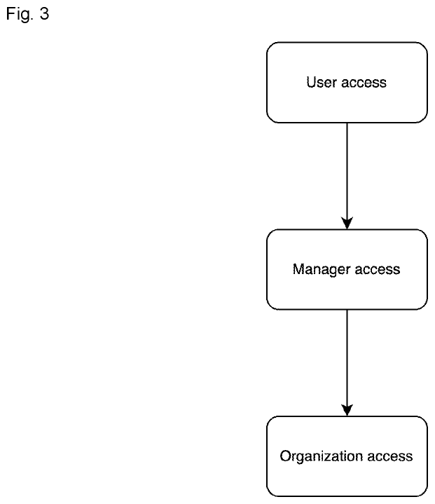

FIG. 3 illustrates an increasing hierarchy of aggregate information from the invention for resource insights

FIG. 1 illustrates an embodiment of the software functionality that integrates scheduling systems with charge code database and computer monitoring systems and provides aggregate information for resourcing and budgetary insights. Starting with a personal information management account that has an associated scheduling system (e.g., Outlook calendar) pulls in information from a charge code database that further categorizes each event on the calendar. Each event is either entered on to the calendar manually or automatically based on computer monitoring systems (e.g., audio, videoconferencing applications, meeting invitations). To generate automatic calendar updates from computer monitoring systems, the invention utilizes metadata and contextual clues to create a new event on the calendar with charge code categorization determined algorithmically and optionally marked for user review/confirmation. The event details are modifiable by designated users to ensure accurate allocation of charge code and time slot to associated events. For designated users/roles reporting of aggregate data is generated based on customizable parameters (e.g., time duration, specific coding) to provide insight on events for multiple dimensions (e.g., users, projects, departments) such that it can be utilized to derive insights or generate required reports (e.g., by generating a timecard or providing resource trends).

FIG. 2 illustrates an embodiment of user operations when utilizing the integrated system as seen in FIG. 1. The user is equipped to manually enter new events or modify new and existing events. For manually entered events, the user details each event including the charge code information and optionally masks personally identifiable information. For automatically generated events through details by computer monitoring systems (e.g., audio and videoconferencing applications), each event is defaulted to a charge code that requires further confirmation/categorization by the user. For existing events linked to computer monitoring systems that deviate from the scheduled time, the event is automatically updated to account for the schedule deviation (e.g., shorter call). For existing static events (i.e., not linked to computer monitoring systems), the user manually adjusts as needed relative to preceding and succeeding events such that the user is alerted of inconsistencies (e.g., overlap or unaccounted for time) that require further attention/confirmation.

FIG. 3 illustrates an embodiment of access hierarchy of aggregate information from the software functionality. For example, a user has edit and view permissions of detailed aggregate information based on the integrated calendar where the user can designate additional editors. The manager has view access by default across multiple users within the affiliated department. The organization has view access by default across multiple users and departments. Depending on organization policies and procedures, different roles or user accounts are created and granted with varying editing permissions as desired.

### EMBODIMENTS

The following examples are given to illustrate various embodiments, which have been made of the present invention. It is to be understood that the following examples are not comprehensive or exhaustive of the many types of embodiments which can be prepared in accordance with the present invention.

In Embodiment 1, the invention is used to manually schedule an event. A user opens their company Outlook calendar to set up a meeting with event details (e.g., title, meeting duration, invitees, location, applicable charge code).

In Embodiment 2, the invention is used to automatically modify a scheduled event that took place. After a user completes a 30-minute event in 40 minutes, the calendar prompts the user to confirm the actual meeting duration, which then updates the scheduled event that took place and the start time of the subsequent event.

In Embodiment 3, the invention is used to auto-populate an unscheduled event that took place. After a user completes an unscheduled meeting through Zoom, the calendar prompts the user to confirm the meeting information auto-populated with event details based on prior user inputs/frequently used information that time blocks their calendar with actual time spent on the event. The user can manually edit any details before confirming the event.

In Embodiment 4, the invention is used to manually modify an unscheduled event that took place. A user performed research on project A through reading topic related articles. The user can manually add an event as detailed in Embodiment 1.

In Embodiment 5, a manager in department A is reviewing aggregate information on project A to understand how many hours were spent across their group to determine budget and headcount allocation for the following year.

While these embodiments, parameters, etc. have been set forth to exemplify and explain the principles of the invention, such are not intended to be limiting. Modifications and changes may become apparent to those skilled in the art, and it is intended that the invention be limited only by the scope of the appended claims.

1. A software functionality that integrates digital scheduling programs including calendar applications with customizable resource accounting categories in a database consisting of variable charge/cost codes to enable timekeeping, resource planning, and budgeting.

2. In the software functionality according to claim 1, it integrates with electronic communication platforms including communication tools, phone, audio/video and conferencing systems to enable auto-population of events on scheduling systems.

3. In the software functionality according to claim 1, it integrates with electronic monitoring systems including communication and conferencing tools, user log-on and inactivity, printer monitoring, and physical location tracking systems to enable recognition of deviations and updating events on scheduling systems.

4. In the software functionality according to claim 1, it learns/adapts such that it will utilize user inputs and corrections to train/refine an algorithm that automatically matches charge codes from the database to scheduled activities and can recommend new charge codes and/or sub-level charge codes as appropriate to track sub-level event/activity/task that may be useful to record separately or together with the main event/activity/task.

5. In the software functionality according to claim 1, it provides customizable and aggregate reporting including timecards, billing/invoicing, trends over seconds, minutes, hours, days, weeks, months, and/or years across multiple dimensions of users, cost centers, tasks, activities, events, projects, groups, and departments.

6. In the software functionality according to claim 1, it provides optional depersonalization, redaction, or anonymization of sensitive information for selected events to protect personally identifiable, confidential, or other sensitive information to comply with requirements comprised of Health Insurance Portability and Accountability Act (HIPAA), privacy, and/or other policies.

7. In the software functionality according to claim 1, it provides traceability and/or delegation of event entry and modifications including who and when changes are made.
